(19) United States
(12) Patent Application Publication
(10) Pub. No.: US 2015/0286823 A1
(43) Pub. Date: Oct. 8, 2015

(54) SYSTEM AND METHOD FOR BOOT SEQUENCE MODIFICATION USING CHIP-RESTRICTED INSTRUCTIONS RESIDING ON AN EXTERNAL MEMORY DEVICE

(71) Applicant: QUALCOMM INCORPORATED, San Diego, CA (US)

(72) Inventors: OR ELNEKAVEH, KFAR VITKIN (IL); YONI KAHANA, BEIT YEHOSHUA (IL); ADI KAROLITSKY, YOKNEAM (IL)

(73) Assignee: QUALCOMM INCORPORATED, San Diego, CA (US)

(21) Appl. No.: 14/267,894

(22) Filed: May 1, 2014

Related U.S. Application Data
(60) Provisional application No. 61/976,491, filed on Apr. 7, 2014.

(51) Int. Cl. G06F 21/57; H04L 9/32; G06F 9/44

(52) U.S. Cl. CPC G06F 21/575; G06F 9/4401; H04L 9/3242; G06F 2221/2129

(57) ABSTRACT

Various embodiments of methods and systems for modification of instructions and/or data associated with one or more boot stages in a boot sequence are disclosed. The authenticity and integrity of the modified instructions and/or data in certain embodiments may be ensured by using a confidential key and a message authentication code (“MAC”) algorithm to generate a MAC output. The MAC output is compared to an expected MAC associated with the modified instructions and/or data. The confidential key is uniquely associated with the system on a chip (“SoC”) or a component of the SoC. In this way, embodiments of the solution guard against unauthorized modification or replacement of the OEM boot instructions.

### STATEMENT REGARDING RELATED APPLICATIONS

This application claims priority under 35 U.S.C. §119 as a non-provisional application of the U.S. Provisional Patent Application 61/976,491 filed on Apr. 7, 2014 and entitled SYSTEM AND METHOD FOR BOOT SEQUENCE MODIFICATION USING CHIP-RESTRICTED INSTRUCTIONS RESIDING ON AN EXTERNAL MEMORY DEVICE, the entire contents of which is hereby incorporated by reference.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

One aspect of PCDs that is in common with most computing devices is the use of electronic memory components for storing instructions and/or data. Various types of memory components may exist in a PCD, each designated for different purposes. Commonly, non-volatile read-only memory (“ROM”) such as mask ROM is located on the system on a chip (“SoC”) and used to store initialization instructions in the form of a first-stage boot loader (“FSBL”) required for the PCD to boot, load operating system (“OS”) software, and transition control of the PCD over to the OS. By contrast, non-volatile programmable memory (“Flash” memory) is located external to the SoC and often used to store additional instructions associated with subsequent stages of a boot sequence such as the second-stage boot loader (“SSBL”), third-stage boot loader (“TSBL”), etc. As one of ordinary skill in the art would understand, while the first-stage boot loader software is inherently trustworthy by virtue of being permanently “burned” into the unchangeable ROM at the time of manufacture, software of subsequent boot sequence stages may be of a trusted status or untrusted status.

Typically, the FSBL verifies the authenticity and integrity of the SSBL before transitioning the boot process over from instructions hard coded in the mask ROM to SSBL instructions stored in Flash. Similarly, the SSBL verifies the authenticity and integrity of instructions associated with a next boot sequence stage before transitioning the boot sequence from the SSBL instructions to the next stage. Using each stage of a boot sequence to verify the authenticity and integrity of the next stage, PCD manufacturers have sought to safeguard the integrity of the coded data and instructions that collectively comprise a boot sequence for a PCD.

Notably, however, demand for an end-user of the PCD to have the ability to modify the boot sequence has led some manufacturers to forego authentication and integrity checking measures in the latter stages of a boot sequence. Consequently, the security of instructions associated with latter stages of a boot sequence may be easily compromised in some systems in the prior art. As such, there is a need in the art for a system and method that provides for secure conditional modification of a latter boot sequence stage while safeguarding the integrity and authenticity of the modified instructions. More specifically, there is a need in the art for a configurable secure boot mode (“CSBM”) system and method.

### SUMMARY OF THE DISCLOSURE

Various embodiments of methods and systems for modification of instructions and/or data associated with one or more boot stages in a boot sequence are disclosed. In certain embodiments, the authenticity and integrity of the modified instructions and/or data may be ensured by using a confidential key as an input to a message authentication code (“MAC”) algorithm that generates a MAC output. The confidential key may be uniquely associated to a particular system on a chip (“SoC”) module, and burned into the SoC. In some embodiments, the confidential key may be derived from another confidential key uniquely associated with, and burned into, the SoC. In this way, embodiments of the solution guard against unauthorized modification or replacement of the OEM boot instructions.

In operation, an exemplary embodiment of a method for configurable secure boot mode (“CSBM”) of boot stages in an SoC recognizes a request from a processing component for coded instructions stored in an external memory component. The authenticity and integrity of the coded instructions may be verified via use of a MAC algorithm and a confidential key that is uniquely associated with, and burned into, the SoC. The coded instructions and/or data requested by the processing component, such as a CPU, may be modified or replacement instructions associated with a particular boot stage of a boot sequence. A particular boot stage of a boot sequence may be, for example, a second-stage boot loader (“SSBL”) or a third-stage boot loader (“TSBL”) or any boot stage having code stored in an external memory device.

Next, using the MAC algorithm and the confidential key from the SoC, the coded instructions, which include an associated MAC value, may be authenticated and integrity checked in a secure environment of the PCD. If the confidential key is successfully used with the MAC algorithm to generate a MAC output from the coded instructions that matches the associated MAC value, the instructions may be presumed authentic and to have an intact integrity. Subsequently, the coded instructions may be provided to the requesting processing component. The boot sequence may continue. Notably, if applying the MAC algorithm and confidential key to the coded instructions generates a MAC output that is inconsistent with the expected MAC output associated with the instructions, it may be assumed that the integrity or authenticity of the coded instructions is invalid and the boot sequence may be terminated.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating an exemplary, non-limiting aspect of a portable computing device (“PCD”) in the form of a wireless telephone for implementing configurable secure boot mode (“CSBM”) methods and systems;

FIG. 2 is a functional block diagram illustrating an embodiment of an on-chip system for executing a first-stage boot loader (“FSBL”) stored entirely in a boot ROM of a PCD;

FIG. 3 is a functional block diagram illustrating an embodiment of an on-chip system for executing boot sequence stages stored in an external memory device of a PCD;

FIG. 4 is a functional block diagram illustrating an embodiment of an on-chip system for executing a boot sequence stage of a PCD using a configurable secure boot mode (“CSBM”) arrangement according to an embodiment of the invention;

FIG. 5 is a logical flowchart illustrating a method for secure modification of instructions and/or data associated with a boot stage, such as a second-stage boot loader (“SSBL”), that resides in an external memory device;

FIG. 6 is a logical flowchart of a boot sequence illustrating a method for secure modification of instructions and/or data associated with a third-stage boot loader (“TSBL”) that may reside in an untrusted external memory device; and

FIG. 7 is a logical flowchart illustrating a portion of the method of FIG. 6 in more detail relative to authenticating and checking integrity of modified code and/or data residing in an untrusted storage block.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, the term “fuse” is meant to refer to a programmable gate controlled by a security controller that receives a request for instructions or data stored at a memory address, such as an address in a mask ROM memory component. A fuse, as would be understood by one of ordinary skill in the art, is a one time programmable memory that may reside in a non-volatile memory component located on a chip. A fuse may contain instructions or data referred to in this description as a “patch” or it may contain a pointer to instructions or data stored in an alternative address. Similarly, in this description, the term “software fuse” is meant to refer to a software-only implementation of a physical fuse that may provide a level of security substantially equivalent to that normally associated with only a physical fuse. Unlike a “fuse” which is a physical one-time programmable gate, a “software fuse” may take the form of instructions and/or data in a reversible or reprogrammable external memory device (e.g., a “Flash” memory device).

In this description, reference to “external memory device” and the like refers to a broader class of non-volatile (i.e., retains its data after power is removed) programmable memory and will not limit the scope of the solutions disclosed. As such, it will be understood that use of the terms envisions any programmable read-only memory or field programmable non-volatile memory suitable for a given application of a solution such as, but not limited to, embedded multimedia card (“eMMC”) memory, electrically erasable programmable read-only memory (“EEPROM”), flash memory, etc.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).”

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, an “ebook” or reader, a media player, a handheld game console, a combination of the aforementioned devices, a laptop computer with a wireless connection, among others.

In this description, the terms “bootstrapping,” “boot,” “boot sequence,” and the like are meant to refer to the initial set of operations that a PCD performs at the direction of the first-stage boot loader (“FSBL”) and subsequent stages when the PCD is initially powered on, or resumes from power saving modes, including, but not limited to, loading the operating system, subsequent images corresponding to different scenarios such as factory provision or normal boot up, and preparing the various PCD components for use. Terms such as “boot phase” and “boot stage” are meant to refer to a portion of an entire boot sequence which one of ordinary skill in the art understands to be collectively comprised of a series of temporally executed boot stages. A boot sequence may begin with a FSBL stage followed by a second-stage boot loader (“SSBL”) stage, a third-stage boot loader (“TSBL”) stage and so on. Notably, exemplary embodiments of the solutions are described within the context of modifying SSBL or TSBL instructions; however, it is envisioned that certain embodiments of the solutions may be applicable to other instruction and/or data sets stored in non-volatile memory and in need of modification.

In this description, the term “subsequent boot stage” or “modifiable boot stage” is meant to refer to any stage in a boot sequence that occurs subsequent to the initial FSBL which is comprised of executable code and/or data stored in one-time programmable and nonreversible ROM. As such, boot stages such as the second-stage boot loader (“SSBL”) or third-stage boot loader (“TSBL”) or main operating system boot loader (“MOSBL”) are exemplary modifiable boot stages that may comprise embodiments of a configurable secure boot mode (“CSBM”) solution as described herein. Therefore, the description of any exemplary CSBM embodiment within the context of a specific modifiable boot stage will not limit the embodiment to the particular stage.

Configurable secure boot mode solutions seek to provide original equipment manufacturers (“OEMs”) with the ability to modify boot instructions associated with modifiable boot stages without risking installation of unauthorized code and/or data (such as an unauthorized operating system). As explained above, an initial FSBL stage in a boot sequence typically authenticates the validity of an SSBL stage before transferring the boot sequence over to the SSBL. Similarly, the SSBL authenticates and verifies a boot stage immediately subsequent to it in the boot sequence, such as a TSBL.

Notably, however, a recent trend has been for some subsequent boot stages to not require authentication in order for the code associated with those stages to be executed in the boot process (e.g., MOSBL, system recovery boot loader, etc. may not require authentication so that a user may freely make modifications). This trend has presented complications to OEMs seeking to maintain the integrity and authenticity of their proprietary code for certain boot stages while still providing an end-user with the ability to introduce custom boot instructions and/or modify original instantiations of boot instructions. Essentially, OEMs have given the user the ability to choose between the inherent security/integrity offered by OEM sanctioned firmware and the freedom to run potentially insecure unsanctioned operating systems. Notably, once a user chooses the security/integrity offered by OEM sanctioned firmware, reversing the decision without presenting an attacker with an opportunity to circumvent the user's original decision may be a complicated undertaking Advantageously, CSBM systems and methods provide OEMs with a way to securely introduce modified boot instructions without opening the window for introduction of an unauthorized code.

It is a further advantage of CSBM embodiments that newly added or upgraded functionality in the PCD may be implemented by using software fuses in an external memory device to introduce an authorized update to the image of a modifiable boot stage. The updated image, which may have been loaded into the external memory device at the time the functionality of the PCD was changed or upgraded, may be authenticated and subjected to an integrity check to ensure its authorized status.

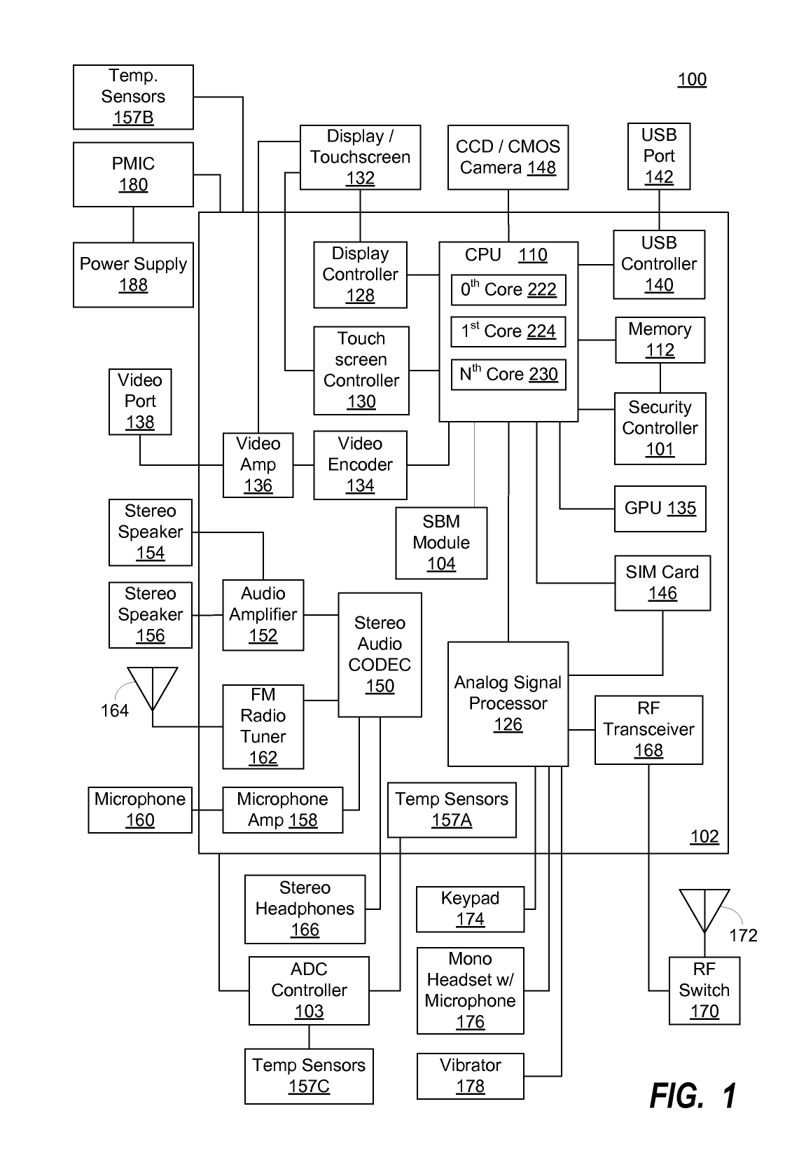

FIG. 1 is a functional block diagram illustrating an exemplary, non-limiting aspect of a portable computing device (“PCD”) 100 in the form of a wireless telephone for implementing configurable secure boot mode (“CSBM”) methods and systems. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the security controller 101 may be formed from hardware and/or software and may be responsible for receiving requests for instructions and/or data associated with a first-stage boot loader (“FSBL”). Similarly, the CSBM module 104, which in some embodiments may comprise the security controller 101, may be responsible for monitoring requests for modifiable instructions and/or data stored in a nonvolatile external memory component 112 and associated with a subsequent boot stage. Using “software fuses,” the CSBM module 104 may authenticate and check the integrity of modifiable code and/or data before fulfilling the request(s). Advantageously, using the software fuses a CSBM module 104 may provide for modification and/or update of modifiable boot stage code stored in an external memory device without compromising the security of the code.

As illustrated in FIG. 1, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136. As depicted in FIG. 1, a universal serial bus (“USB”) controller 140 is coupled to the CPU 110. Also, a USB port 142 is coupled to the USB controller 140. A memory 112, which may include a PoP memory, a cache 116, a mask ROM/Boot ROM 113, a one time programmable (“OTP”) memory, an external memory device 115 such as a flash memory, etc., may also be coupled to the CPU 110.

A subscriber identity module (“SIM”) card 146 may also be coupled to the CPU 110. Further, as shown in FIG. 1, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 1, a stereo audio CODEC 150 may be coupled to the analog signal processor 126. Moreover, an audio amplifier 152 may be coupled to the stereo audio CODEC 150. In an exemplary aspect, a first speaker 154 and a second speaker 156 are coupled to the audio amplifier 152. FIG. 1 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1 further indicates that a radio frequency (“RF”) transceiver 168 may be coupled to the analog signal processor 126. An RF switch 170 may be coupled to the RF transceiver 168 and an RF antenna 172. As shown in FIG. 1, a keypad 174 may be coupled to the analog signal processor 126. Also, a mono headset with a microphone 176 may be coupled to the analog signal processor 126. Further, a vibrator device 178 may be coupled to the analog signal processor 126. FIG. 1 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller 103. However, other types of thermal sensors 157 may be employed.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, the PMIC 180 and the power supply 188 are external to the on-chip system 102. It will be understood, however, that one or more of these devices depicted as external to the on-chip system 102 in the exemplary embodiment of a PCD 100 in FIG. 1 may reside on chip 102 in other exemplary embodiments.

In a particular aspect, one or more of the method steps described herein may be implemented by executable instructions and parameters stored in the memory 112 or as form the security controller 101 and/or its fuses. Further, the security controller 101, the memory 112, the instructions stored therein, or a combination thereof may serve as a means for performing one or more of the method steps described herein.

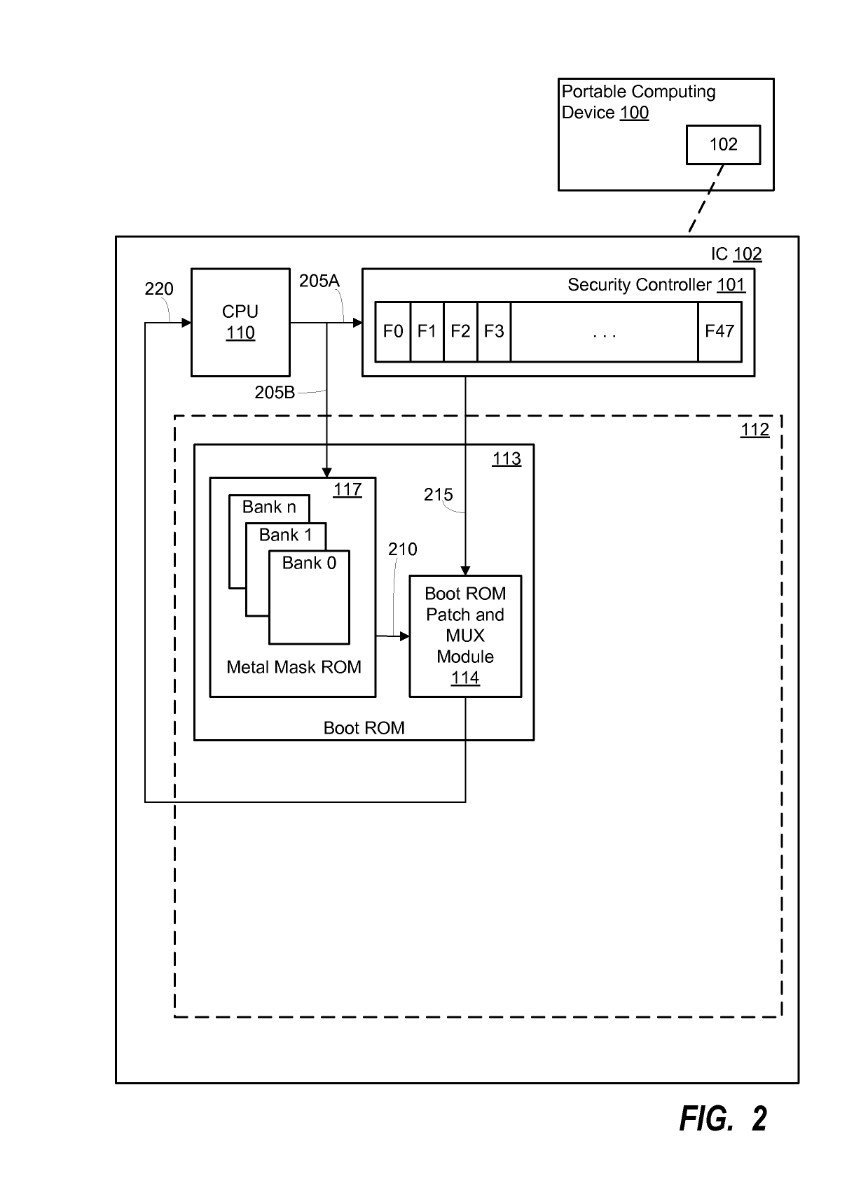

FIG. 2 is a functional block diagram illustrating an embodiment of an on-chip system for executing a first-stage boot loader (“FSBL”) stored entirely in a boot ROM 113 of a PCD 100. As would be understood by one of ordinary skill in the art, the FSBL may be the initial set of instructions used for bootstrapping the PCD 100 and may reside in a one time programmable (“OTP”) ROM 113. By virtue of residing in OTP ROM, the FSBL is inherently secure and difficult, if not altogether impractical, to modify by an end-user as opposed to other off-chip nonvolatile programmable memory 112.

As indicated by the arrows 205A, 205B in the FIG. 2 illustration, during a boot sequence, addresses emanate from the CPU 110 and are directed to both the security controller 101 and the mask ROM 117 contained in the boot ROM 113. As is understood by one of ordinary skill in the art, the CPU 110 could be fetching instructions and/or data associated with the FSBL that are stored at the address(es) in the mask ROM 117.

If the particular instructions or data stored at the requested address has been patched, i.e. a “patch valid” bit has been set for that address by the security controller 101, the patch data held by a fuse (F0, for example) is forwarded (arrow 215) to the Boot ROM Patch and Multiplexor Module (“MUX” module) 114. The MUX module 114 overrides the FSBL data coming out of the metal mask ROM 117 (arrow 210) and returns the patch code or patch data, as the case may be, to the CPU 110 (arrow 220) instead of the original instantiation of the code or data stored in the mask ROM 117. If no valid patch data is held by a fuse of the security controller 101, the MUX module 114 returns the original instructions and/or data to the CPU 110 (arrow 220).

Notably, the particular embodiment of the on-chip system 102 illustrated in FIG. 2 is limited in its capacity to modify the FSBL instructions and data originally instantiated in the mask ROM 117 by the capacity of the fuses (F0 . . . F47) to carry patch instructions and data. Even so, the nature of the FSBL code existing in the mask ROM 117 and fuses of the security controller 101 results in an inherent level of security that makes the FSBL code difficult to modify. Before the FSBL stage completes and transfers the boot sequence to a set of SSBL instructions, the FSBL may authenticate the SSBL instructions to ensure that they have not been altered.

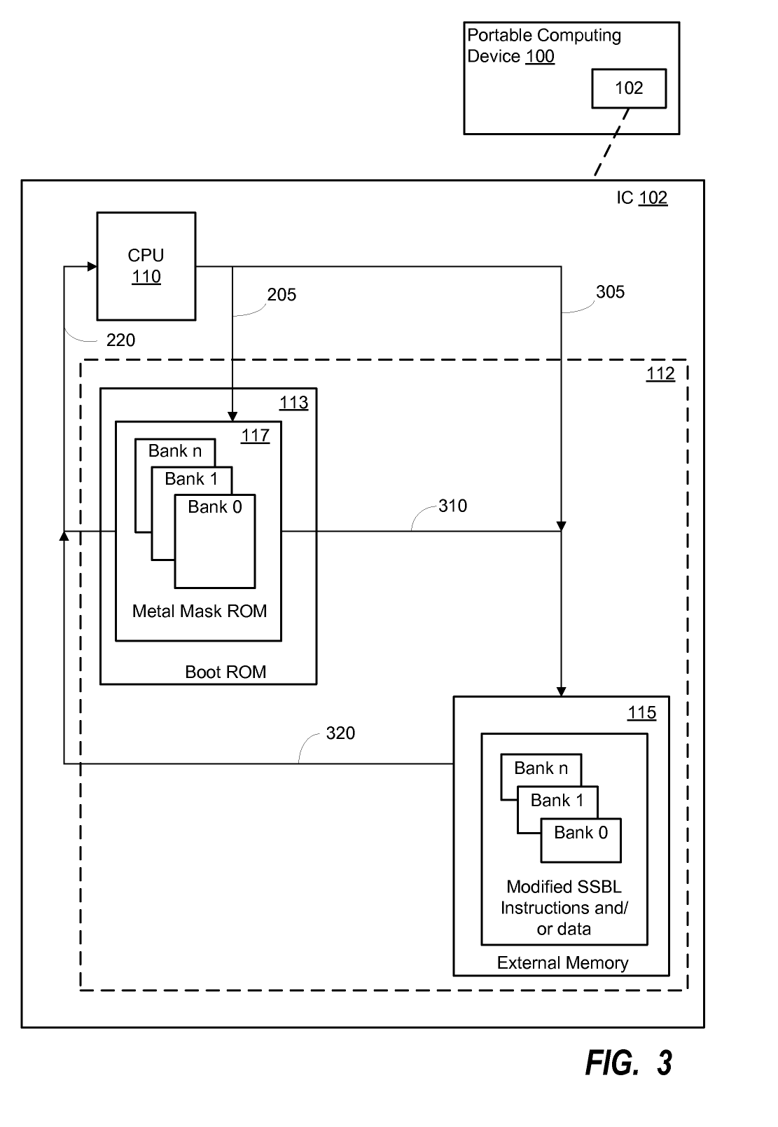

FIG. 3 is a functional block diagram illustrating an embodiment of an on-chip system 102 for executing modifiable boot sequence stages stored in an external memory device 115 of a PCD 100. Notably, it is envisioned that the external memory device 115 may be a nonvolatile memory component, a volatile memory component, or a combination of nonvolatile and volatile memory. In the FIG. 3 illustration, it can be seen that an external memory component 115 is closely coupled to the boot ROM 113 such that at the completion of the FSBL stage described in FIG. 2, the boot sequence may be transferred to a subsequent boot stage instantiated as software in the external memory component 115 (arrow 310). An example of a boot stage subsequent to a FSBL stage is a second-stage boot loader (“SSBL”), as would be understood by one of ordinary skill in the art. The FSBL may load the SSBL from external nonvolatile memory (e.g. Flash) to DRAM, for example. Once in the DRAM, the integrity of the SSBL may be checked by the FSBL before control of the boot sequence is transferred to the SSBL.

Once the boot sequence is transferred from the FSBL to the SSBL, the CPU 110 continues the boot sequence according to the instructions fetched from the external memory component 115. The SSBL may then transfer the boot sequence over to a boot stage subsequent to it, such as a third-stage boot loader (“TSBL”). The CPU 110 may then continue to fetch instructions (arrow 305) from the external memory device 115 according to the TSBL, for example. The loop of requests (arrow 305) and returns of the requested instructions (arrow 320), according to each subsequent boot stage, continues until the boot sequence terminates.

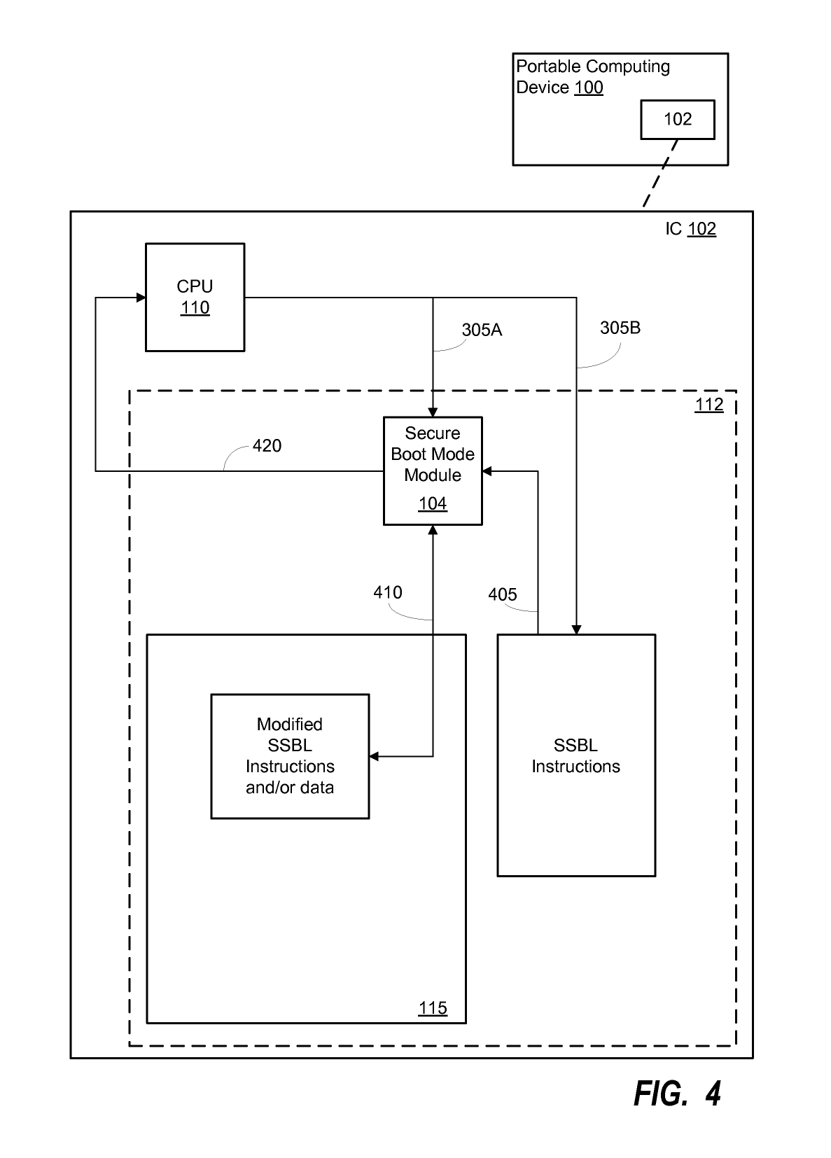

FIG. 4 is a functional block diagram illustrating an embodiment of an on-chip system 102 for executing a modifiable boot sequence stage of a PCD 100 using a configurable secure boot mode (“CSBM”) arrangement according to an embodiment of the invention. Similar to the request process described above, the CPU 110 may request (arrows 305) instructions and/or data associated with a modifiable boot sequence stage such as an SSBL. The request 305 may be served directly on the memory device 112 (arrow 305B) and on a configurable secure boot mode (“CSBM”) module 104. The CSBM module 104 may then query (arrow 410) modified SSBL instructions stored as “software fuses” in the external memory device 115. The modified SSBL instructions, if present and associated with a message authentication code (“MAC”), may be authenticated by the CSBM module 104 using a MAC algorithm and a confidential key uniquely associated with the SoC.

The confidential key may be uniquely associated with, and burned into, the chip 102. Because the modified instructions are only used if a MAC algorithm applied to the modified instructions generates a MAC output that is identical to the expected MAC that is associated with the modified instructions, the authenticity and integrity of the instructions may be maintained and guarded from external attacks or replacement with damaged code. That is, although both unauthorized code and authorized code may exist in an unencrypted and readily executable form in an external memory device of the PCD, CSBM embodiments may only proceed to execute the code if its authenticity and integrity is successfully verified using the confidential key burned into the SoC. In this way, unauthorized attacks that use replacement code and/or data or swap out memory components on the SoC in an effort to circumvent authorized boot stages may be successfully thwarted without sacrificing the ability for authorized boot sequence modifications.

Returning to the FIG. 4 illustration, the requested instructions associated with the original instantiation of the SSBL code may be returned to the CPU 110 via the CSBM module 104 (arrows 405, 420). Alternatively, if the CSBM module 104 authenticates replacement SSBL instructions (such as untrusted nonvolatile external memory 115), the CSBM module 104 may override the original instructions and return the authorized replacement instructions and/or data (arrows 410, 420). In this way, an embodiment of a CSBM solution may provide for software fuses that a manufacturer may leverage to modify boot instructions without compromising the security of the boot sequence. Notably, the essentially unlimited number of programming cycles for software fuses presents an advantageous aspect for CSBM embodiments over prior art use of hardware fuses which are limited in number. Other advantages of software fuses according to certain CSBM embodiments over prior art solutions using hardware fuses may include, but not be limited to, field programmability of modified boot stage instructions and/or data, and extended storage capacity for modified instructions and/or data.

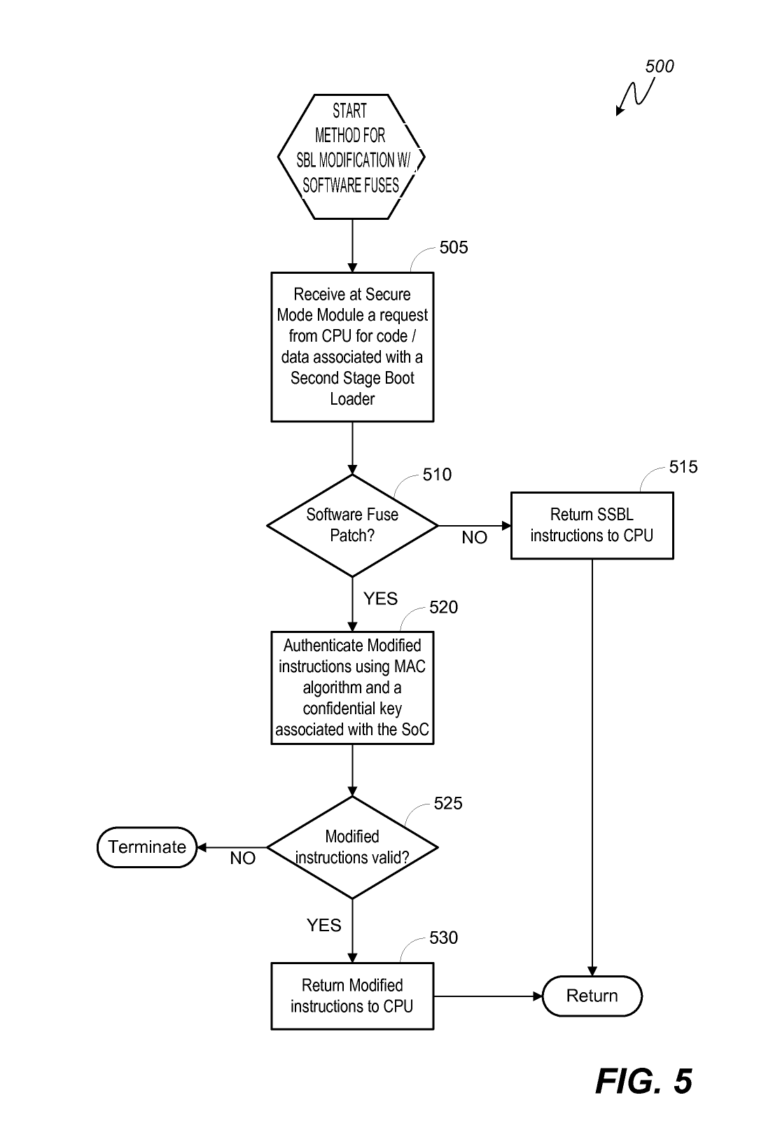

FIG. 5 is a logical flowchart illustrating a method 500 for secure modification of instructions and/or data associated with a modifiable boot stage in the form of a second-stage boot loader (“SSBL”). Although the exemplary method 500, as well as other exemplary embodiments described herein, is being described within the context of an SSBL, it is envisioned that certain embodiments of the solutions may be applicable to other modifiable boot stages and, as such, the scope of the solutions will not be limited in applicability to SSBL or TSBL stages. Further, although the method 500 is described within the context of securely modifying an original instantiation of a modifiable boot stage, it will be understood that certain embodiments of CSBM solutions may be used to altogether replace original instantiations of a modifiable boot stage without risking unauthorized replacement or compromising the security of the replacement code.

Beginning at block 505, a request for instructions and/or data associated with a SSBL is recognized by a CSBM module 104. At decision block 510, the CSBM module 104 may determine if a software fuse in an untrusted storage device, such as a nonvolatile external memory device 115, contains modified code associated with the requested instructions and/or data. If modified code is not present, the “no” branch is followed to block 515 and the requested instructions and/or data from the original SSBL instantiation is returned to the CPU 110.

If, however, the CSBM module 104 determines that replacement instructions and/or data associated with the request is available, the “yes” branch is followed to block 520. At block 520, the modified instructions may be authenticated and checked for integrity using a confidential key uniquely associated with, and burned into, the SoC as an input to a MAC algorithm 102. As described above, the modified boot data may be authenticated in a secure environment so as not to jeopardize the confidentiality of the key. In this way, unauthorized replacement data could not be authorized without knowledge of the key, as an expected MAC associated with the replacement data must have been generated from the MAC algorithm using the confidential key. Without knowledge of the confidential key, an expected MAC value associated with the replacement data will not equate to a MAC output generated by the CSBM module 104 using the confidential key and MAC algorithm. Other cryptographic means are envisioned and would occur to those of ordinary skill in the art; however, it is also envisioned that a novel aspect of some CSBM embodiments is that the authentication and integrity verification of modified boot code may be based on a confidential key that is uniquely associated with, and burned into, the SoC itself 102.

Returning to the method 500, at decision block 525 the authenticity and integrity of the modified instructions is verified. If the instructions are verified by the CSBM module 104 to be authentic using the confidential key associated with the SoC 102 (i.e., a MAC value generated by the CSBM module 104 matches a MAC value associated with the instructions), the “yes” branch is followed to block 530 and the modified instructions are returned to the CPU 110. If the modified instructions are not verified to be authentic or authorized, the “no” branch is followed and the boot sequence is terminated.

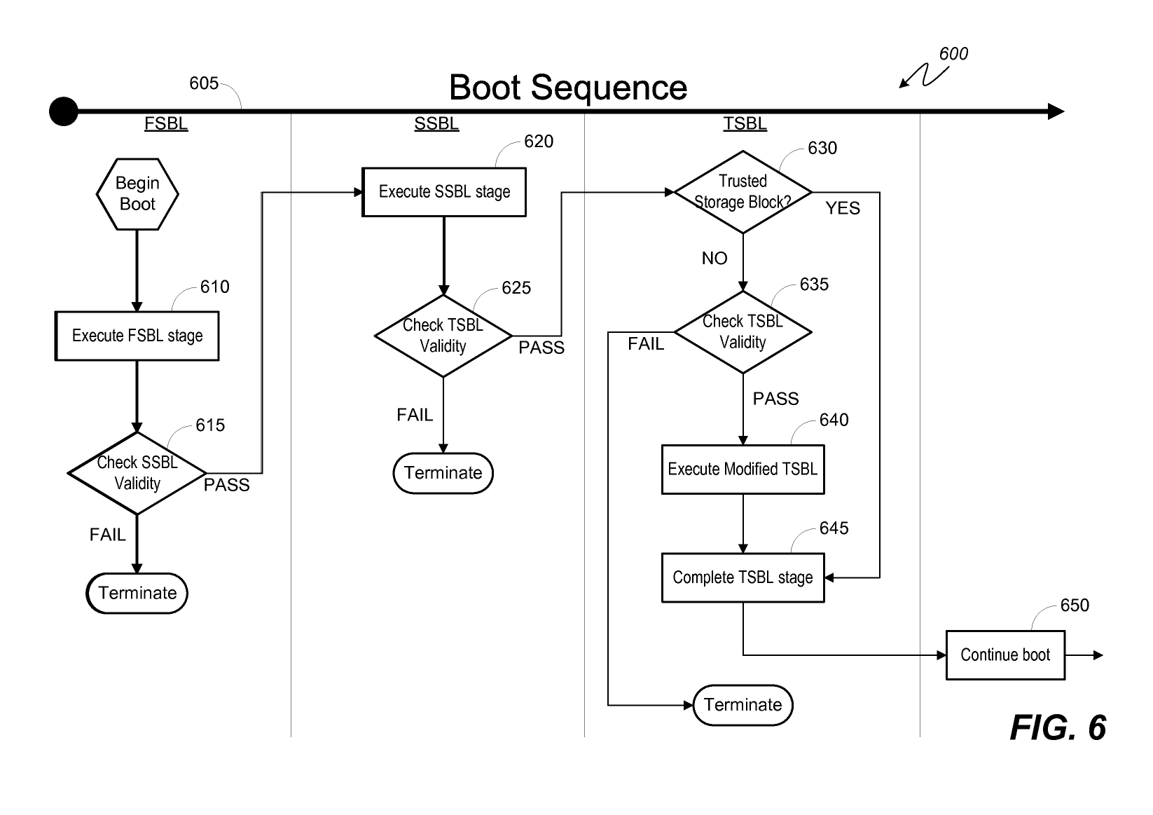

FIG. 6 is a logical flowchart of a boot sequence illustrating a method 600 for secure modification of instructions and/or data associated with a third-stage boot loader (“TSBL”) that may reside in an untrusted external memory device 115. The FIG. 6 illustration includes a temporal representation of the boot sequence in the form of an arrow 605 translating from left to right. The method 600 begins at the initiation of the boot sequence in the form of FSBL instructions. As described above, the FSBL instructions/data may be instantiated in a trusted, irreversible ROM device, as is understood by one of ordinary skill in the art.

At block 610, the FSBL is executed. Before the FSBL is completed, the subsequent boot stage, i.e. the SSBL, is verified for authenticity and integrity at decision block 615. If the SSBL is not authenticated, the “fail” branch is followed and the boot sequence is terminated. If, however, the SSBL is authenticated then the “pass” branch is followed and the boot sequence transitions to the SSBL boot stage. The SSBL boot stage, like the FSBL stage, may be associated with instructions and/or data that are instantiated in a trusted memory device, such as an OTP memory.

At block 620, the SSBL is executed. Before the SSBL is completed, the subsequent boot stage, i.e. the TSBL, is verified for authenticity and integrity at decision block 625. If the authentication fails, the “fail” branch is followed and the boot sequence terminates. Otherwise, the “pass” branch is followed and the boot sequence is transitioned to the TSBL. Notably, in the exemplary CSBM embodiment 600 illustrated by FIG. 6, the TSBL may be modifiable by virtue of modified code and/or instructions residing in an untrusted storage device, such as an off-chip, nonvolatile or volatile memory device.

At decision block 630, the CSBM embodiment may determine if modified TSBL instructions and/or data are available and in an untrusted storage. If the modified TSBL is stored in a trusted storage, like the FSBL and SSBL for example, the method 600 may follow the “yes” branch to block 645 and the TSBL is executed. If, however, the modified TSBL resides in an untrusted storage, the method 600 may proceed from decision block 630 by following the “no” branch to decision block 635.

At decision block 635, the integrity and authenticity of the instructions and/or data stored in the untrusted storage block is verified, as through use of a MAC algorithm and a confidential key uniquely associated with, and burned into, the SoC as described above. If the verification fails, the method 600 follows the “fail” branch from decision block 635 and the boot sequence terminates. If, however, the modified instructions stored in the untrusted storage block are successfully verified using the key uniquely associated with the SoC 102 to generate a MAC output that is consistent with a MAC value associated with the modified instructions, the method 600 follows the “pass” branch to block 640.

At block 640, the authenticated and integrity-checked TSBL code from the unsecure storage block is executed and the method moves to block 645 where the modifiable boot stage is completed. From block 645, the boot sequence proceeds to a subsequent boot stage, such as may be associated with a MOSBL, and continues at block 650.

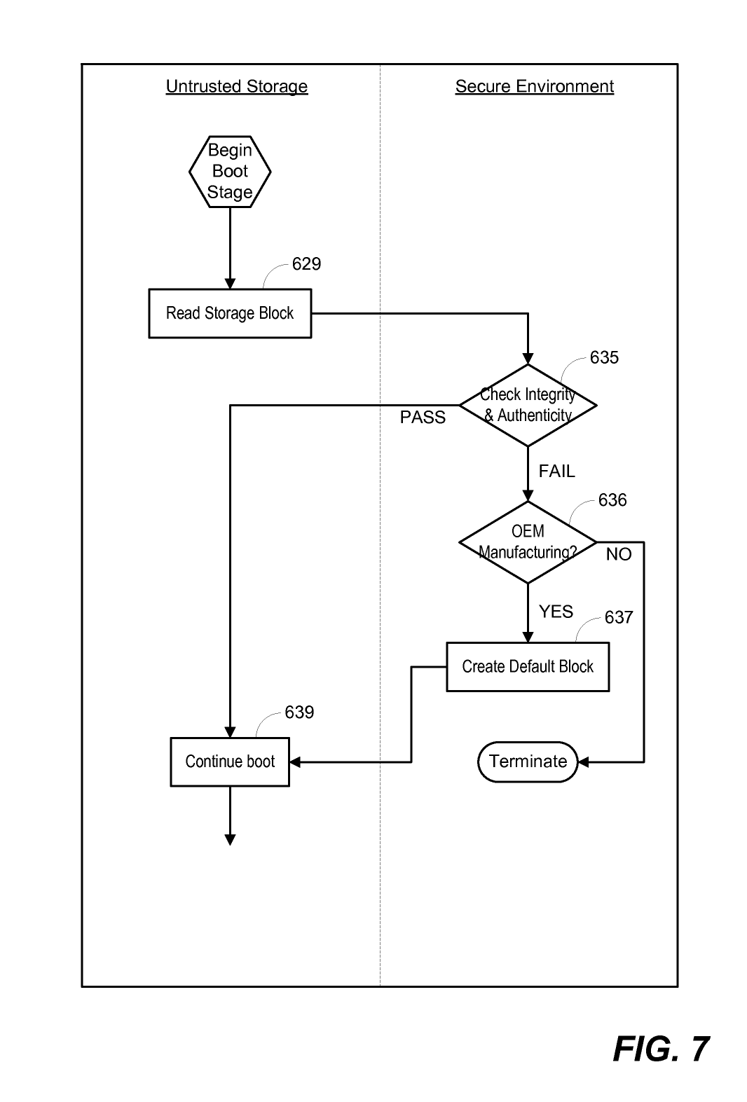

FIG. 7 is a logical flowchart illustrating a portion of the method 600 of FIG. 6 in more detail relative to authenticating and checking integrity of modified code and/or data residing in an untrusted storage block 705. Prior to decision block 630 in the method 600, the storage block of instructions and/or data associated with the TSBL boot stage is read at block 629. As described above, if the storage block is an untrusted storage block capable of containing unauthorized code and/or data, the method 600 proceeds to decision block 635. In the FIG. 7 illustration, the portion of the method 600 beginning with decision block 635 may be conducted within a secure environment so as to maintain the confidentiality of the confidential key. If the modified code and/or data are successfully verified for authenticity and integrity at block 635, the “pass” branch is followed to block 639 and the boot stage continues to block 640 using the modified instructions and/or data.

If the authenticity and integrity check fails at decision block 635, the “fail” branch is followed to decision block 636 and the method 600 seeks to determine whether the code is associated with manufacturing purposes. If not, the “no” branch is followed and the boot sequence is terminated. If the code is associated with manufacturing purposes, then the “yes” branch is followed to block 637 and a default block of instructions is created. The method moves to block 639 and the boot stage continues to block 640.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Therefore, although selected aspects have been illustrated and described in detail, it will be understood that various substitutions and alterations may be made therein without departing from the spirit and scope of the present invention, as defined by the following claims.

What is claimed is:

1. A method for modifying boot stages in a system on a chip (“SoC”), the method comprising:
receiving a request from a processor for coded instructions associated with a particular boot stage;
determining that modified instructions reside in an untrusted memory component;
verifying that the modified instructions are authorized by successfully generating a message authentication code (“MAC”) output via application of a MAC algorithm and confidential key, wherein the confidential key is uniquely associated with the SoC and the MAC output is equivalent to an expected MAC associated with the modified instructions; and
returning the modified instructions to the processor.

2. The method of claim 1, wherein the coded instructions are associated with a second-stage boot loader (“SSBL”).

3. The method of claim 1, wherein the coded instructions are associated with a third-stage boot loader (“TSBL”).

4. The method of claim 1, wherein the untrusted memory component is a flash memory component.

5. The method of claim 1, wherein verifying that the modified instructions are authorized comprises verifying the authenticity and integrity of the modified instructions.

6. The method of claim 1, wherein:
verifying that the modified instructions are authorized comprises determining that the modified instructions are invalid and creating a default block of instructions; and
returning the modified instructions to the processor comprises returning the default block of instructions.

7. The method of claim 1, wherein:
verifying that the modified instructions are authorized comprises determining that the modified instructions are invalid; and
returning the modified instructions to the processor comprises terminating the boot sequence.

8. The method of claim 1, wherein the confidential key is burned to the SoC.

9. A computer system for modifying boot stages in a system on a chip (“SoC”), the system comprising:
a configurable secure boot mode (“CSBM”) operable for:
receiving a request from a processor for coded instructions associated with a particular boot stage;
determining that modified instructions reside in an untrusted memory component;
verifying that the modified instructions are authorized by successfully generating a message authentication code (“MAC”) output via application of a MAC algorithm and confidential key, wherein the confidential key is uniquely associated with the SoC and the MAC output is equivalent to an expected MAC associated with the modified instructions; and
returning the modified instructions to the processor.

10. The computer system of claim 9, wherein the coded instructions are associated with a second-stage boot loader (“SSBL”).

11. The computer system of claim 9, wherein the coded instructions are associated with a third-stage boot loader (“TSBL”).

12. The computer system of claim 9, wherein the untrusted memory component is a flash memory component.

13. The computer system of claim 9, wherein verifying that the modified instructions are authorized comprises verifying the authenticity and integrity of the modified instructions.

14. The computer system of claim 9, wherein:
verifying that the modified instructions are authorized comprises determining that the modified instructions are invalid and creating a default block of instructions; and
returning the modified instructions to the processor comprises returning the default block of instructions.

15. The computer system of claim 9, wherein:
verifying that the modified instructions are authorized comprises determining that the modified instructions are invalid; and
returning the modified instructions to the processor comprises terminating the boot sequence.

16. The computer system of claim 9, wherein the confidential key is burned to the SoC.

17. A computer system for modifying boot stages in a system on a chip (“SoC”), the method comprising:
means for receiving a request from a processor for coded instructions associated with a particular boot stage;
means for determining that modified instructions reside in an untrusted memory component;
means for verifying that the modified instructions are authorized by successfully generating a message authentication code (“MAC”) output via application of a MAC algorithm and confidential key, wherein the confidential key is uniquely associated with the SoC and the MAC output is equivalent to an expected MAC associated with the modified instructions; and
means for returning the modified instructions to the processor.

18. The computer system of claim 17, wherein the coded instructions are associated with a second-stage boot loader (“SSBL”).

19. The computer system of claim 17, wherein the coded instructions are associated with a third-stage boot loader (“TSBL”).

20. The computer system of claim 17, wherein the untrusted memory component is a flash memory component.

21. The computer system of claim 17, wherein the means for verifying that the modified instructions are authorized comprises means for verifying the authenticity and integrity of the modified instructions.

22. The computer system of claim 17, wherein:
means for verifying that the modified instructions are authorized comprises means for determining that the modified instructions are invalid and means for creating a default block of instructions; and
means for returning the modified instructions to the processor comprises means for returning the default block of instructions.

23. The computer system of claim 17, wherein:
means for verifying that the modified instructions are authorized comprises means for determining that the modified instructions are invalid; and
means for returning the modified instructions to the processor comprises means for terminating the boot sequence.

24. A computer program product comprising a computer usable medium having a computer readable program code embodied therein, said computer readable program code adapted to be executed to implement a method for modifying boot stages in a system on a chip (“SoC”), said method comprising:
receiving a request from a processor for coded instructions associated with a particular boot stage;
determining that modified instructions reside in an untrusted memory component;
verifying that the modified instructions are authorized by successfully generating a message authentication code (“MAC”) output via application of a MAC algorithm and confidential key, wherein the confidential key is uniquely associated with the SoC and the MAC output is equivalent to an expected MAC associated with the modified instructions; and
returning the modified instructions to the processor.

25. The computer program product of claim 24, wherein the coded instructions are associated with a second-stage boot loader (“SSBL”).

26. The computer program product of claim 24, wherein the coded instructions are associated with a third-stage boot loader (“TSBL”).

27. The computer program product of claim 24, wherein the untrusted memory component is a flash memory component.

28. The computer program product of claim 24, wherein verifying that the modified instructions are authorized comprises verifying the authenticity and integrity of the modified instructions.

29. The computer program product of claim 24, wherein:
verifying that the modified instructions are authorized comprises determining that the modified instructions are invalid and creating a default block of instructions; and
returning the modified instructions to the processor comprises returning the default block of instructions.

30. The computer program product of claim 24, wherein:
verifying that the modified instructions are authorized comprises determining that the modified instructions are invalid; and
returning the modified instructions to the processor comprises terminating the boot sequence.
